(19) United States
(12) Patent Application Publication
(10) Pub. No.: US 2018/0339208 A1
(43) Pub. Date: Nov. 29, 2018

(54) Method For Analyzing The Game Of A User Of A Racket

(71) Applicant: MOVEA, Grenoble (FR)

(72) Inventors: Lubin Kerhuel, Bayonne (FR); Cyrille Soubeyrat, Reaumont (FR); Joe Youssef, Grenoble (FR); Anne Frassati, Voreppe (FR); Agnes Duval, Saint Martin D'Heres (FR); Sebastien Riccardi, Brezins (FR)

(21) Appl. No.: 15/904,113

(22) Filed: Feb. 23, 2018

Related U.S. Application Data
(63) Continuation of application No. 14/399,619, filed on Nov. 7, 2014, now abandoned.

(30) Foreign Application Priority Data
May 10, 2012 (FR) 1254257
Oct. 10, 2012 (FR) 1259662

(51) Int. Cl. A63B 60/46; A63B 24/00; G09B 19/00; A63B 69/38; A63B 49/08; A63B 71/06

(52) U.S. Cl. CPC A63B 60/46; A63B 71/0622; G09B 19/0038; A63B 2220/833; A63B 2220/803; A63B 2220/64; A63B 2220/62; A63B 2220/53; A63B 2220/40; A63B 2220/34; A63B 2220/12; A63B 2024/0071; A63B 2024/0068; A63B 24/0003; A63B 69/38; A63B 49/08; A63B 24/0006

(57) ABSTRACT

A method for analyzing the game of a user of a racket (Ra) includes detecting an impact on the racket (Ra) from representative measurements of a shock to the racket (Ra) provided by a sensor assembly comprising at least one sensor sensitive to shocks linked to the racket (Ra) in a fixed manner in terms of movement. A moment of impact is associated with a detected impact, from the measurements transmitted by the sensor assembly. The impacts that are not related to strokes from a set of pre-determined strokes are eliminated on the basis of angular rotational velocity measurements, provided by a gyrometer (G) of the sensor assembly with at least one measurement axis and linked to the racket (Ra) in a fixed manner in terms of movement, taken during an interval of time around said moment of impact.

### CROSS-REFERENCE TO RELATED APPLICATIONS

This application is a continuation of U.S. patent application Ser. No. 14/399,619 filed Nov. 7, 2014, which is the National Stage of International Application No. PCT/EP2013/058179, filed on Apr. 26, 2013, which claims the benefit of French Application No. 1254257, filed May 10, 2012, and French Application No. 1259662, filed Oct. 10, 2012. The contents of all of these applications are incorporated herein by reference.

### BACKGROUND OF THE INVENTION

### Field of the Invention

Embodiments of the invention relates to a method for analyzing the game of a user of a racket, wherein an impact, notably of an associated projectile, is detected on the racket.

### Description of the Related Art

The term projectile is understood to refer to a ball, in general, in games or sports such as tennis, table tennis, squash, racquetball, or, for example, a shuttlecock for badminton.

Systems are known comprising rackets equipped with sensors to provide data related to the player.

United States patent publication no. 2011/183787 relates to a racket equipped with at least one sensor, for example an accelerometer, an anemometer, a pressure sensor, a stress sensor or a piezoelectric sensor.

This document is very general and concerns a racket equipped with at least one sensor, and a device incorporated into the racket, controlled by a motor, to modify at least one feature of the racket, for example stiffness or string tension, as a function of the sensor signal. Such a device seems to have a high price and weight.

U.S. Pat. No. 5,757,266 relates to an electronic system designed to monitor the capacity of a player to correctly center his ball on the stringbed of his racket on which a plurality of sensors, distributed around the periphery of the stringbed or strings of the racket, make it possible to detect relative arrival times of the waves created by an impact of a ball on the racket. Based on these signals, the position of the impact of the ball on the stringbed can be computed. This computation is carried out by a microprocessor embedded in the racket. Furthermore, a display device is provided on the racket to provide the player with information relating to the centering of the ball.

Such a system is not suitable for determining impacts on the racket that are not ball impacts. Furthermore, the number of sensors is large and the cost is high.

United States patent publication no. 2005/0239583 relates to a striking or percussive device, such as a racket, a bat or a baton, equipped with sensors including an acceleration sensor, to determine the velocity of the displaced object or of the striking device.

The described system seems relatively limited to evaluating a velocity of a striking or percussive element, or a velocity of the displaced object.

U.S. Pat. No. 6,134,965 relates to a racket equipped with vibration sensors, the frequency of which is analyzed to determine the velocity of the struck ball.

The described system seems relatively limited to evaluating a velocity of a striking or percussive element, or a velocity of the ball.

### SUMMARY OF THE INVENTION

One aim of embodiments of the invention is to propose an improved method for analyzing the game of a user of a racket and of an associated projectile, making it possible to analyze the player's game in real or delayed time.

Another aim of embodiments of the invention is to improve the precision of the detection of an impact of the projectile on the racket.

Thus, according to an aspect of embodiments of the invention, a method is proposed for analyzing the game of a user of a racket, wherein:
an impact on the racket is detected from representative measurements of a shock to the racket provided by a sensor assembly comprising at least one sensor sensitive to shocks linked to the racket in a fixed manner in terms of movement;
a moment of impact is associated with a detected impact, from the measurements transmitted by the sensor assembly; and
the impacts that are not related to strokes from a set of pre-determined strokes are eliminated on the basis of angular rotational velocity measurements, provided by a gyrometer of the sensor assembly with at least one measurement axis and linked to the racket in a fixed manner in terms of movement, taken during an interval of time around said moment of impact.

The game can be tennis, squash, table tennis, badminton, or any racket sport.

Such a method makes it possible to improve analysis of the game of a user of a racket and of an associated projectile, making it possible to analyze the game of the player in real or delayed time.

Such a method also makes it possible to eliminate impacts that are not part of the game in order to analyze only the strokes of the game.

In a method of implementation, said sensor assembly comprising at least one vibration sensor, an impact on the racket is detected from measurements of vibrations transmitted by the vibration sensor, by comparison of a parameter representing the vibrations with a threshold.

A vibration sensor, for example a piezoelectric sensor, makes it possible to detect easily and at low cost.

According to one method of implementation, said sensor assembly comprising an accelerometer with at least one measurement axis, an impact on the racket is detected when a parameter depending on the variations over time of the axial linear accelerations and/or variations over time of the angular rotational velocities is above a threshold.

The use of such sensors makes it possible to analyze the movements of the strokes, even if they saturate the sensors at times.

In one method of implementation, impacts that are not related to strokes from a set of predetermined strokes are eliminated, on the basis of a comparison between a value representing the angular rotational velocity along an axis during an interval of time around the moment of impact and a threshold.

Thus, only strokes that are part of the game are analyzed.

According to one method of implementation, said gyrometer comprises at least two measurement axes, impacts that are not related to strokes from a set of predetermined strokes are eliminated, on the basis of a comparison between a first value representing the angular rotational velocity along a first axis during an interval of time around the moment of impact and a second value representing the angular rotational velocity along a second axis during said interval of time.

Thus, false impact detections are avoided, notably lateral impacts, for example when the player hits the side of his racket against his sports shoes to remove clay, or else when he hits the side of his racket in his hand.

In one method of implementation, said gyrometer comprises three measurement axes and said sensor assembly comprises at least one accelerometer with three measurement axes, the attitude of the racket is determined with respect to a terrestrial frame of reference from the measurements of the axial linear accelerations and the measurements of the angular rotational velocities along said measurement axes.

The fact of determining, continuously, the attitude of the racket with respect to a terrestrial frame of reference makes it possible to avoid detections of strokes that one does not wish to detect.

According to one method of implementation, a stroke is classified among a set of strokes by association of a stroke with a movement of the racket for which, around the moment of impact, the rotational velocity of the racket is essentially along a determined axis and the attitude of the racket is essentially at a determined attitude.

The terms orientation or attitude refer to the angular separations of the axes of the reference frame linked to the racket with respect to the terrestrial frame of reference axes. This attitude data item is conventionally expressed by a quatemion rotational matrix, Euler angles or any other suitable representation. For determined strokes the attitude of the racket is preferably not random.

It is therefore easy to determine a stroke among a set of strokes, such as a service, a forehand stroke or a backhand. The player or his coach can thus evaluate the correct execution of the various strokes by the player, to improve his technique.

Indeed, for a movement to be a stroke, it is desirable to move the racket correctly and have the racket in a particular orientation. For example, in tennis, it is hard to serve with the racket horizontal.

Thus, the determination of the stroke and the evaluation of the correct execution of a stroke are improved.

According to one method of implementation, a stroke is classified among a set of strokes, furthermore on the basis of an item of information representing the left- or right-handedness of the player, and of the sign of the angular rotational velocity along the determined axis.

Precision is thus improved. The set of the strokes is larger and the invention makes it possible to discern more strokes, with a higher precision.

For example, the item of information representing the left- or right-handedness of the player is provided by the player or learnt automatically during the game, for example in particular phases of the game.

If the player is learning during the game, the player does not need to “manually” enter whether he is left or right handed.

In one method of implementation, a stroke is detected among a set of strokes by associating a stroke with a determined form of a projection signal of a vector representing the attitude of the racket onto an axis determined over an interval of time around the moment of impact.

Thus, the player can pay attention to the correct execution of the various strokes, obtain statistics on his game, and improve his technique.

According to one method of implementation, said gyrometer comprises at least two measurement axes and the impact being due to a projectile, the intensity of an effect given to the projectile is determined, at the moment of impact, from a comparison of the angular rotational velocity along a first axis during an interval of time around the moment of impact and of the angular rotational velocity along a second axis during said interval of time.

Thus, the player obtains statistics on the use that he makes of the effects, on their intensity and can learn and progress in the use of effects.

In one method of implementation, said axes comprise a first transverse axis in the direction of the width of the racket and a second transverse axis in the direction of the thickness of the racket, and a backspin effect is differentiated from a topspin effect on the basis of the sign of the angular rotational velocity along the second transverse axis and an orientation of the racket during said interval of time.

It is then easy to tell the difference between a backspin effect and a topspin effect.

According to one method of implementation, the axes comprise a longitudinal axis oriented from the shaft toward the head of the racket, said gyrometer with at least one measurement axis is capable of delivering a rotational velocity along the longitudinal axis, and the impact is due to a projectile striking a longitudinal impact strip on the stringbed of the racket, wherein the impact of the projectile having taken place, is determined from a variation of the angular rotational velocity along the longitudinal axis over an interval of time immediately following the impact.

Thus, the player has access to a statistic on the centering of the projectile on the stringbed of the racket, he can improve his impact position when he strikes the projectile, and thus optimize his regularity, his precision and his energy loss.

In one method of implementation, said gyrometer with at least one measurement axis is capable of delivering a rotational velocity along a first transverse axis in the direction of the width of the racket, and said determination of the longitudinal impact strip is corrected by an item of information representing the velocity of the racket around the moment of impact.

The determination of the longitudinal impact strip is thus improved.

According to one method of implementation, the sensor assembly comprises at least one vibration sensor and the impact is due to a projectile striking a radial impact strip, wherein the impact of the projectile having taken place, is determined on the basis of the energy and the phase of the signal transmitted by the vibration sensor due to the impact.

Thus, the player has access to a statistic on the centering of the projectile on the stringbed of the racket, he can improve the position of impact of the projectile, and optimize his regularity, his precision and limit his loss of energy.

Thus, by knowing at what velocity the ball is struck, it is possible to train oneself to optimize the stroke, improve the velocity of the strokes, strike harder, but without losing precision.

According to one method of implementation, the sensor assembly comprises an accelerometer with three measurement axes and/or a gyrometer (G) with three measurement axes, and the impact is due to a projectile, and during a start of a phase of the game, a launch velocity of the projectile is respectively computed from the measurements of the axial accelerations and/or the measurements of the angular rotational velocities during the phase of acceleration of the racket preceding the impact.

Thus, by knowing at what velocity the ball is struck, it is possible to train oneself to optimize the stroke, improve one's ball velocity on these opening phases of the game, strike harder, but without losing precision.

In one method of implementation, the computed launch velocity of the projectile is corrected on the basis of the knowledge of a zone of impact of the projectile and/or of the intensity of the effect given to the projectile.

Thus, the precision of the computation of the velocity is improved.

According to one method of implementation, in addition, the location of the player on the game space is determined from the data provided by a system for locating the player or the racket.

Thus, it is possible to obtain more statistics by recovering the distribution of the strokes made by the player as a function of his position on the court. This information makes it possible to highlight behaviors of the player, and to improve them.

In one method of implementation, the sensor assembly comprises at least one accelerometer, and when during an interval of time around the moment of impact the signals of said sensor or sensors are saturated, an extrapolation of the signals provided by the sensor or sensors is carried out over said saturation time interval.

Thus, even in the case of saturation of the sensors, the precision remains excellent.

In one method of implementation, one provides, in real or delayed time, qualitative and/or quantitative statistics relative to the player's manner of playing.

It is thus possible for the player or his coach to be able to track his level of play either directly, or in a delayed manner, to improve. The level of play can be tracked in a qualitative and/or quantitative way.

Also proposed, according to another aspect of the invention, is a system for analyzing the game of a user of a racket, comprising:
means for detecting an impact on the racket from measurements representing a shock experienced by the racket provided from a sensor assembly comprising at least one sensor sensitive to shocks linked in a fixed manner to the racket in terms of movement;
means for associating a moment of impact with a detected impact, on the basis of the measurements transmitted by the sensor assembly;
a gyrometer, from the sensor assembly, with at least one measurement axis and linked in a fixed manner to the racket in terms of movement; and
means for eliminating the impacts not related to strokes from a set of predetermined strokes on the basis of angular rotational velocity measurements, provided by said gyrometer, taken during an interval of time around said moment of impact.

For example, said sensor assembly is mounted in a fixed manner in an outer casing equipped with fixing means adapted to be mounted/dismounted at will on the racket, or is mounted in a fixed manner on the racket.

According to an embodiment, said sensor assembly is mounted on the racket in a fixed manner in such a way that two measurement axes of said sensor assembly form an angle of 45° with a first transverse axis in the direction of the width of the racket and a longitudinal axis in the direction of the length of the racket.

In the case of the outer casing equipped with fixing means adapted for being mounted/dismounted as desired on the racket, the system comprises an autonomous part which can be adapted to any racket.

In the case of the outer casing mounted in a fixed manner on the racket, the system comprises sensors mounted on the racket in a permanent manner, which makes it possible to optimize the operation to the features of the racket.

In one embodiment, the sensor assembly is mounted in a fixed manner on the racket and comprises an accelerometer and a gyrometer arranged in the shaft of the racket at the bottom of the grip, and a vibration sensor arranged on the shaft of the racket between the grip and the bottom of the head of the racket.

This is a case of sensor placement giving improved results.

### BRIEF DESCRIPTION OF THE DRAWINGS

The invention will be better understood after studying a few embodiments described by way of in no way limiting examples and illustrated by the appended drawings wherein:

FIG. 1 schematically illustrates a method for analyzing the game of a user of a racket and an associated projectile according to one embodiment of the invention;

FIG. 2 schematically illustrates the axes of the racket corresponding to the measurements, or to which one refers the measurements of the sensors linked to the racket in a fixed manner in terms of movement, according to one embodiment of the invention;

FIG. 2a schematically illustrates the measurement axes or the axes to which one refers the measurements of the sensors linked to the racket in a fixed manner in terms of movement, inclined at 45° with respect to the racket axes, according to one embodiment of the invention;

FIG. 3 schematically illustrates the elimination of unwanted impacts, according to one embodiment of the invention;

FIG. 4 illustrates the determination of the attitude or orientation of the racket, according to one embodiment of the invention;

FIG. 5 schematically illustrates the detection of a stroke among a set of strokes, according to one embodiment of the invention;

FIG. 6 schematically illustrates the orientation of the longitudinal axis of the racket with respect to the gravity vector, by projection of the longitudinal axis onto the gravity vector, according to one embodiment of the invention;

FIG. 7 schematically illustrates the evolution of this projection during a service, according to one embodiment of the invention;

FIG. 8 schematically illustrates the orientation of the first transverse axis x in the direction of the width of the racket with respect to the gravity vector, by projection of the first transverse axis onto the gravity vector, according to one embodiment of the invention;

FIG. 9 schematically illustrates a table of the result of a determination of a forehand or backhand stroke, according to one embodiment of the invention;

FIG. 10 schematically illustrates three longitudinal impact strips, one high-impact strip, one medium-impact strip, and one low-impact strip, of the racket, according to one embodiment of the invention;

FIG. 11 schematically illustrates the variation of the angular rotational velocity along the longitudinal axis z oriented from the shaft toward the head of the racket during an impact of the projectile, according to one embodiment of the invention;

FIG. 12 schematically illustrates three radial impact strips of the racket, according to one embodiment of the invention;

FIG. 13 schematically illustrates the phase t of the signal conveyed by the piezoelectric sensor as a function of the normalized energy E_{E1}, in the case of FIG. 12, according to one embodiment of the invention;

FIG. 14 schematically illustrates the evolution over time of the racket during a service, according to one embodiment of the invention;

FIG. 15 schematically illustrates the evolution over time of the acceleration of the racket in a service according to one embodiment of the invention; and

FIG. 16 illustrates the computation of the velocity of the projectile according to one embodiment of the invention.

In all the figures, the elements having the same references are similar. The examples described relate to tennis, without however being limiting, because the invention is applicable to any type of game or sport requiring the use of a racket and an associated projectile.

### DETAILED DESCRIPTION OF THE PREFERRED EMBODIMENTS

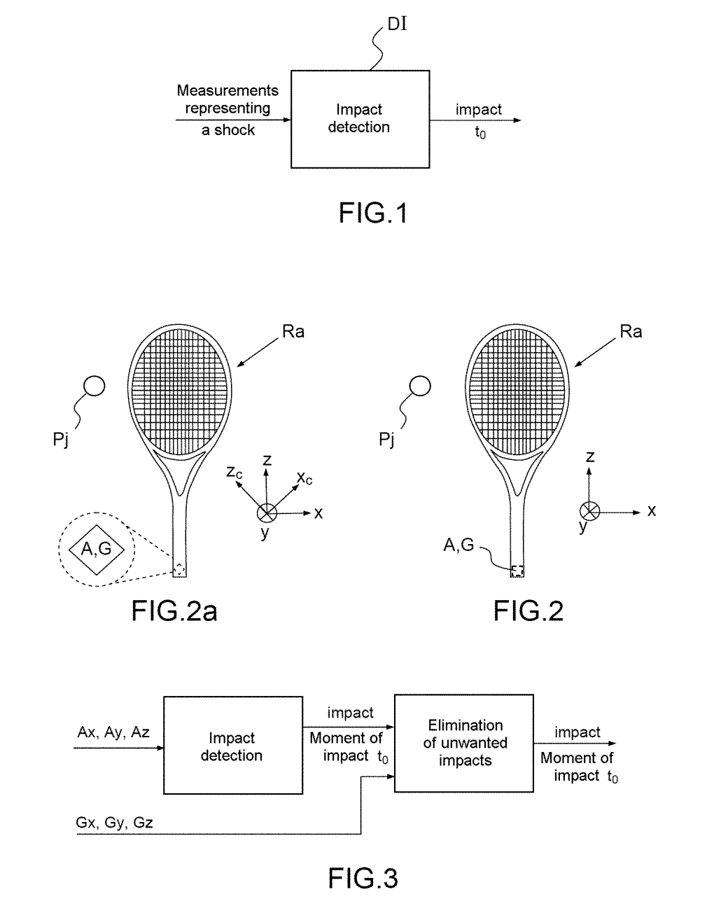

FIG. 1 illustrates a method for analyzing the game of a user of a racket and of an associated projectile, wherein an impact of the projectile is detected on the racket, with which a moment of impact to is associated from measurements representing a shock experienced by the racket, for example by a sensor assembly comprising a gyrometer with at least one measurement axis. The sensor assembly may furthermore comprise at least one vibration sensor, and/or at least one accelerometer with at least one measurement axis. Once the moment of impact to is known, the data supplied by the sensors around the moment of impact to is analyzed to determine whether it is a stroke among the set of strokes, and to determine other parameters of the game, such as the effect, the velocity, etc.

As the example in FIG. 2 illustrates, the sensor assembly comprises an accelerometer with at least one measurement axis and a gyrometer with at least one measurement axis, the measurement axes being, for example, directly orthogonal to the accelerometer A and to the gyrometer G correspond respectively to a first transverse axis x in the direction of the width of the racket Ra, a second transverse axis y in the direction of the thickness of the racket Ra, and a longitudinal axis z oriented from the shaft to the head of the racket Ra. In the case of tennis, the associated projectile Pj is a tennis ball.

In a variant, as illustrated in FIG. 2a, the axes of the sensor assembly can be different from the axes of the racket (transverse in the direction of the width of the racket Ra, transverse in the direction of the thickness of the racket Ra, and oriented from the shaft toward the head of the racket Ra). In this case, as illustrated in FIG. 2a, the sensor assembly can comprise a first axis x_{c} offset by 45° with respect to a transverse axis x in the direction of the width of the racket Ra and a second axis z_{c} offset by 45° with respect to a transverse axis z in the direction of the length of the racket.

In this embodiment, the risks of sensor saturation can be reduced. Indeed, at the beginning of a service, there is a high acceleration along the z-axis because the racket Ra is tangent to the trajectory of the racket Ra, as illustrated on the right-hand part of FIG. 14. In this embodiment, the acceleration Az along the z-axis of the racket is measured by the sensors along the axes x_{c} and z_{c}. Each sensor measures an acceleration Az/\sqrt{2}. Consequently, it is possible to measure a higher acceleration Az along the z-axis (by a factor of \sqrt{2}) before the accelerometers begin to saturate.

By analogy, it is possible to deduce that a similar advantage exists in the computation of the rotational velocity along the first transverse axis x of the racket with the gyrometer G. During the typical strokes of a racket, the rotational velocity is highest along the first transverse axis of the racket.

In the embodiment in FIG. 2a, the y-axis of the sensors is identical to the second transverse axis y of the racket Ra. If, furthermore, the y-axis of the sensors is turned to 45 degrees with respect to the second transverse axis y of the racket Ra, by analogy, a factor of \sqrt{3} is gained instead of a factor of \sqrt{2} because the measurements are made along three axes instead of along two axes.

When an impact is detected, a moment of impact to is associated from variations over time with the axial linear accelerations Ax, Ay and Az delivered by the accelerometer A along the x-, y- and z-axes respectively.

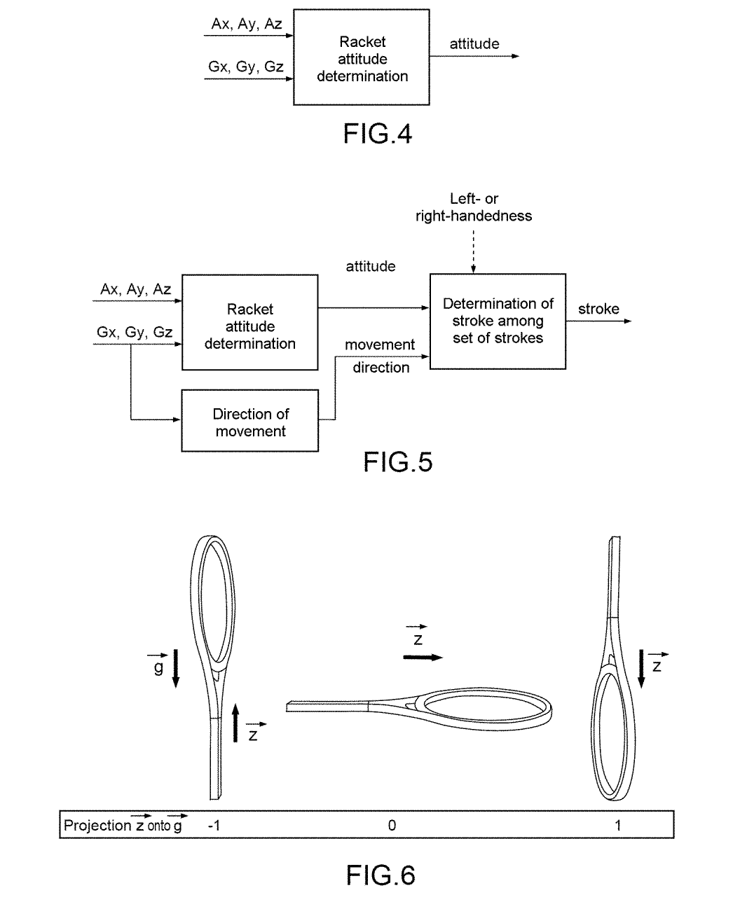

Furthermore, one eliminates impacts not linked to strokes from a set of strokes predetermined from the angular rotational velocities Gx, Gy and Gz along the x-, y- and z-axes. Thus, as illustrated in FIG. 3, if the impact originates from a stroke not forming part of the set of strokes, the analysis is not continued. In a variant, in combination, a module for determining the attitude of the racket Ra can be incorporated, as illustrated in FIG. 4.

The set of predetermined strokes can, for example, comprise the following strokes: service, forehand, and backhand.

An impact not linked to a stroke from this set can correspond to an impact of the racket Ra on a sports shoe to dislodge clay, or correspond to rebounds of the ball on the stringbed of the racket Ra made by a player who is going to serve, between two periods of play. For example, for such strokes, the stringbed of the racket is horizontal, and it can therefore not be a service, forehand, or backhand.

For example, it is possible to detect an impact of the projectile Pj on the racket Ra when a norm of an acceleration variation vector DVA=(DV Ax; DV Ay; DV Az), the components of which are the temporal derivatives

$$( \frac{dAx}{dt} ; \frac{dAy}{dt} ; \frac{dAz}{dt} )$$

of the axial linear accelerations (Ax; Ay; Az), is above a threshold S1. In a variant, it is possible to detect an impact of the projectile Pj on the racket Ra when a norm of an acceleration variation vector DVA=(αDV Ax; βDV Ay; γDV Az), the components of which are based on the temporal derivatives

$$( α \frac{dAx}{dt} ; β \frac{dAy}{dt} ; γ \frac{dAz}{dt} )$$

of the axial linear accelerations (Ax; Ay; Az), (α, β and γ being arbitrary) and is above a threshold S1.

The norm can, for example, be the Euclidian norm or norm 2 (∥DV A∥₂={square root over (|DV Ax|²+|DV Ay|²+|DV Az|²))}, the norm 1 (∥DV A∥₁=|DV Ax|+|DV Ay|+|DV Az|), the norm p (∥DV A∥ₚ=(|DV Ax|^{p}+|DV Ay|^{p}+|DV Az|^{p})^{p}), or the infinite norm (∥DV A∥_{∞}=max(|DV Ax|; |DV Ay|; |DV Az|)).

Indeed, for impact detection, even in the event of saturation of the accelerometer A, a large variation can be detected by comparison with a threshold, in this case the threshold S1.

For example, an impact is detected by testing if the norm 1 of DV A is above the threshold S1, for example equal to 11:

$$\vert \frac{dAx ( t )}{dt} \vert + \vert \frac{dAy ( t )}{dt} \vert + ⌈ \frac{dAz ( t )}{dt} \vert > S 1$$

The value of the threshold S1 is conventionally obtained by training on a test basis.

Furthermore, it is possible to take into account, for the detection of an impact, a first comparison between a first value representing the angular rotational velocity Gₓ along the first transverse axis x during a first interval of time Δt1 immediately preceding the impact and a threshold S2. False impact detections are avoided, corresponding for example to a rotation of the racket about the y-axis, which can correspond to a striking of the racket against a shoe or the net. In this case it is taken into account that the main axis of the movement is the first transverse axis x.

This first comparison can, for example, be written in the following form:

∫ₜ_{₁}^{t}^{₀}|Gₓ(t)|dt>S2,

wherein ∫ₜ_{₁}^{t}^{₀}|Gₓ(t)|dt represents the first value and the threshold S2 can, for example, have a value of 30, t₀ being the time of impact and t₁ preceding the impact, for example t₁=t₀−50 ms. It is also possible to choose another interval of time so as to select the signal portions that are appropriate and representative of the movement of the racket around the impact, without experiencing the shock effects that generally distort the signals of the sensors.

The value of the threshold S2 is conventionally obtained by training on a test basis. S2 is low so as not to miss strokes lacking power.

It is also possible to take into account, separately or in combination with the previous, for the detection of an impact, a second comparison between a first value representing the angular rotational velocity Gₓ in relation to the first transverse axis x during the first interval of time Δt1 immediately preceding the impact and a second value representing the angular rotational velocity G_{y} in relation to the second transverse axis y during the first interval of time Δt1. False impact detections, notably lateral impacts, for example when the player hits the side of his racket Ra against his sports shoes to remove the clay, or else when he hits the side of his racket Ra in his hand, are avoided. Thus one takes into account the fact that the movement along the first transverse axis x is greater than along the two other y- and z-axes.

This second comparison can, for example, be written in the following form:

$${\int }_{{t}_{1}}^{{t}_{0}} \vert {G}_{x} ( t ) \vert dt > C 1 \times {\int }_{{t}_{1}}^{{t}_{0}} \vert {G}_{y} ( t ) \vert dt$$

wherein:
∫ₜ_{₁}^{t}^{₀}|Gₓ(t)|dt represents the first value,
C1×∫ₜ_{₁}^{t}^{₀}|Gₓ(t)|dt represents the second value, and
C1 is a criterion that can for example have a value of ½.

Furthermore, it is possible to determine the attitude or the orientation of the racket Ra with respect to a terrestrial frame of reference from the axial linear accelerations Ax, Ay and Az and from the angular rotational velocities Gx, Gy and Gz along the x-, y- and z-axes, as illustrated in FIG. 4.

Several physical devices and algorithm types can be used to estimate the attitude, the angular velocity of the attitude of an object equipped with sensors of accelerometer and gyrometer type.

Concerning modules for computing orientation using these sensor types, the reference is made to the products of Movea™ or the products of XSens™, or Intersense™ with for example the product family InertiaCube™ or the products of CrossBow™.

Reference is made, for example, to the article “An extended Kalman filter for quaternion-based orientation estimation using MARG sensors” by Marins, J. L., Xiaoping Yun, Bachmann, E. R., McGhee, R. B., and Zyda, M. J., published in “Intelligent Robots and Systems”, 2001, 2001 IEEE/RSJ. This article gives access to many other references that it is useful to analyze.

Concerning gyrometers, it is for example possible to use the gyrometers supplied by Analog Devices™ with the reference ADXRS300™, or the ITG3200™ from Invensense™ or the gyrometers supplied by STM™.

Concerning accelerometers, it is for example possible to use the accelerometers with the reference ADXL103 from Analog Devices™ and LIS302DL by STM™. FreeScale™ and Kionix™ also supply such sensors.

Various algorithms can be used to correct the perturbations and/or default of each sensor and thus merge the signals of the various sensors and therefore estimate the attitude. Reference is made, for example, to International patent application no. WO2010/007160, the contents of which are incorporated herein by reference. Alternative methods may also be used. The best-known algorithms are the Kalman filter, optimization methods, or additional filtering methods.

Qualitatively, to supply the orientation data item, it is possible to use inertial devices embedded in the object comprising accelerometer and gyrometer combinations. The accelerometers make it possible to measure the orientation of the object with respect to a fixed vector related to the earth, i.e. terrestrial gravity. The gyrometers measure the inherent angular velocity of the movements of the object. The gyrometers are generally affected by a significant temporal drift that must be regularly corrected. The accelerometer makes it possible to supply an absolute orientation with respect to a terrestrial frame of reference. Gyrometers are effective for estimating orientations during phases of rapid movements, between two absolute orientations.

The sensors can be microelectromechanical systems or MEMS, optionally integrated, or made using other non-integrated technologies. Each type of sensor can include one, two or three axes. Today, it is natural to integrate sensors with three axes in products, this technology now being commonplace. In some applications, a single sensor type (in this case generally with three axes) can be used, if the perturbations or temporal drift can be considered negligible so that the final orientation data item, desirable for embodiments of the invention, is precise enough, or be corrected without resorting to another sensor type. Ideally, however, a combination of at least two sensor types will be used for embodiments of the invention, for example accelerometer and gyrometer.

Note that these two sensor types can contribute complementary information with a view to estimating the orientation. The tri-axial version gyrometer supplies angular velocity measurements in relation to three Degrees of Freedom (DOF), and makes it possible to estimate the attitude by integration of the angular velocity. It therefore makes it possible to compute a relative orientation with respect to a given orientation. This principle of estimating the orientation is subject to a drift because of the integration operation and the gyrometer bias, if the gyrometer is used alone. The tri-axial version accelerometer supplies two items of angular information (the angles of roll and yaw) that are absolute with respect to a terrestrial frame of reference, but is subject to perturbations when the movements are not quasi-static since it measures at the same time the acceleration parameters due to the movement. The combination of the two sensors makes it possible to supply measurements of absolute attitude with respect to a terrestrial frame of reference, with the exception of the heading (angle with respect to the North in the terrestrial frame of reference) with respect to the earth, whose value can only be estimated using the gyrometer and therefore as a relative value with respect to a reference orientation.

Given the attitude of the racket Ra, a stroke is detected among a set of strokes, by associating a stroke with a movement for which, at the moment of impact, the velocity of the racket Ra is essentially along a determined axis, as illustrated in FIG. 5. For example, for a service, using the projection of the z-axis onto the gravity g, and the way the user lifts his racket is tracked.

Furthermore, it is also desirable to use, for detecting a stroke among a set of strokes, an item of information representing the left- or right-handedness of the player, and representing the direction of the movement determined from the sign of the angular rotational velocity along the determined axis. The information item representing the left- or right-handedness of the player can be supplied by the player or learnt during the game. During a service, the player turns the racket around the z-axis, and the direction of the movement gives the information on the left- or right-handedness of the player (Rotation Gz>0: right-handed, and Gz<0: left-handed).

Furthermore, it is also possible to use for the detection of a stroke among a set of strokes, an associating a stroke with a determined form of the projection of the attitude of the racket Ra onto a determined axis over an interval of time comprising at least one portion immediately preceding the impact.

To illustrate what has just been said, the following set is taken as the set of strokes: {service; forehand; backhand}. The axes of interest are the z-axis for a service and the x-axis for a forehand or a backhand, as illustrated in the following example.

To determine whether a stroke is a service, a tracking of the orientation of the longitudinal axis \vec{z} of the racket Ra with respect to the gravity vector \vec{g} is used, as illustrated in FIG. 6. The attitude of the racket Ra is determined from the measurements from the accelerometer A and the gyrometer G, then the projection of the longitudinal axis \vec{z} of the racket Ra on the gravity vector \vec{g} is computed. As illustrated in FIG. 6, according to the position of the racket Ra, the value of the projection of onto \vec{g} can be seen.

Thus, when the racket Ra is vertical oriented upwards, this projection has a value of −1, when the racket Ra is horizontal, this projection has a value of 0, and when the racket Ra is vertical oriented downward, this projection has a value of 1.

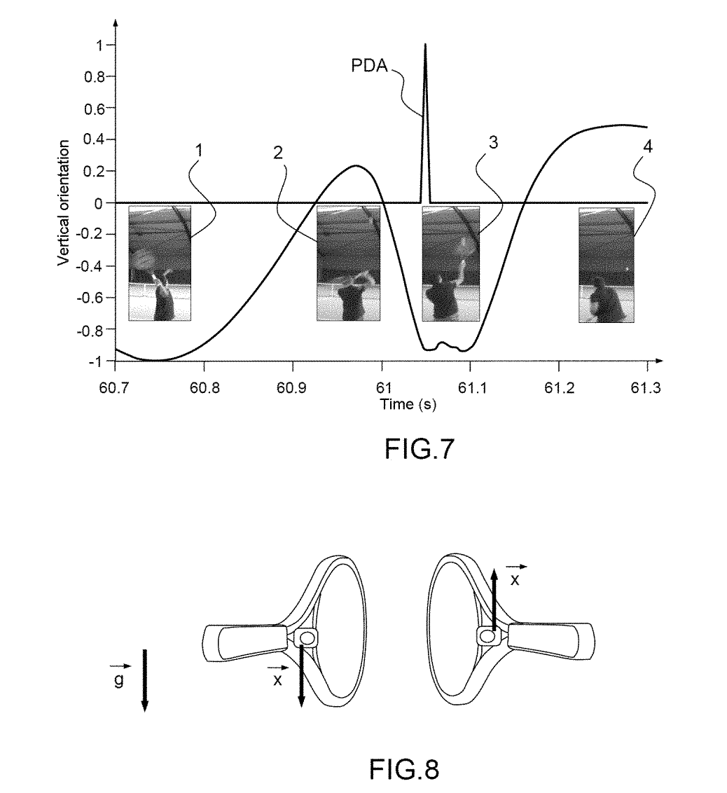

FIG. 7 illustrates an example of the evolution of this projection over a service, during which, at the moment of impact of the ball (impact detection peak PDA), the racket Ra is substantially vertical oriented upward, and the projection of \vec{z} onto \vec{g} has a value of substantially −1.

Different players can have different services. To cover all types of service, different criteria can be used, for example three criteria are used to determine a service:
the first criterion C1: the projection of the projection of \vec{z} onto \vec{g} at the moment of impact must correspond to a substantially vertical position oriented upward, i.e. C1<−0.82. The majority of services are detected by this criterion.
a second criterion C2: the amplitude of the movement, represented by the difference between the projection of z onto g at the local maximum P2 before the impact and the projection at the local minimum P3 at the moment of the impact, i.e. C2>1.71. Before testing the criterion C2, it is made sure that at the moment of impact the projection of z onto g is below −0.5. This criterion makes it possible to detect a service for which the ball is struck before or after the vertical position oriented upward of the racket Ra.
C3: the projection at the local maximum P2 C3>0.84. Before testing the second criterion C2, it is desirable to be sure that at the moment of impact the projection is below −0.5. This criterion covers a service during which the player projects the racket Ra quite far to the back, but strikes the ball with the racket Ra not totally vertical.

Generally, the thresholds required for the operation of the method can be advantageously determined on a test basis representing the scenarios of use.

These criteria are tested in the order C1, C2, C3, and if one of them is met, a service is detected, If none of the three criteria is met, no service is detected. Note that the second criterion C2 and the third criterion C3 comprise time constraints.

Next or in parallel, it is possible to detect if the stroke performed by the player is a forehand or backhand stroke.

The service movement can also be used to determine whether the player is left- or right-handed. During the swing movement in the service the player turns the racket Ra about the x-axis. This rotation can be measured by the gyroscope z, and from its sign, it is possible to deduce if the player is left- or right-handed (Rotation Gz>0: right-handed, and Gz<0: left-handed).

To tell a forehand stroke apart from a backhand, three factors are preferably taken into account.
first of all, the dominant hand: it is desirable to determine whether the player is left- or right-handed. It is desirable to tell between a forehand stroke of a right-handed player and a backhand stroke of a left-handed player, as well as between a backhand stroke of a right-handed player and a forehand stroke of a left-handed player. The dominant hand can be deduced from the swing of the service, or can be known from an input by the user;
next the orientation of the racket Ra: to determine the orientation of the racket Ra, the orientation of the axis \vec{x} of the racket Ra with respect to the gravity vector \vec{g} is computed. The sign of the projection of \vec{x} onto \vec{g} gives us the orientation of the racket Ra as illustrated in FIG. 8, the x-axis is vertical oriented downward when the projection of \vec{x} onto \vec{g} has a value of 1 and the x-axis is vertical oriented upward when the projection of \vec{x} onto \vec{g} has a value of −1;
finally, the direction of the movement before the impact: the direction of the movement is determined from the sign of the angular rotational velocity supplied by the gyrometer G relative to the axis \vec{x}.

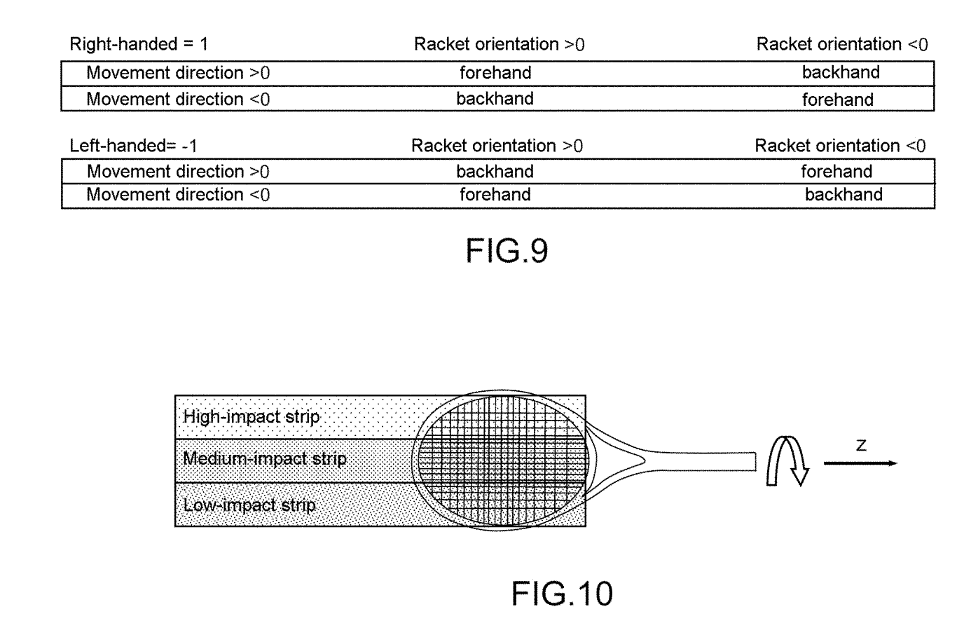

If the value 1 is associated with a right-handed player and the value −1 with a left-handed player, it is possible to determine the type of stroke by multiplying these three factors. If the result is positive (i.e. has a value of 1) the stroke is a forehand stroke, and if the result is negative (i.e. has a value of −1) the stroke is a backhand stroke. The various cases are represented in FIG. 9.

It is also possible, in a variant or in combination, to determine the presence of an effect given to the projectile Pj at the moment of impact from a third comparison of the angular rotational velocity along an axis with the angular rotational velocity along another axis, for example of the angular rotational velocity Gₓ along the first transverse axis x during a first interval of time immediately preceding the impact and of the angular rotational velocity G_{y} along the second transverse axis y during said first interval of time.

A backspin effect is distinguished from a topspin effect from the sign of the angular rotational velocity G_{y} along the second transverse axis y and of the orientation or attitude of the racket Ra during said first interval of time.

For example, the player can give a backspin or topspin effect to the ball by adjusting the angular velocity Gy of the racket Ra upon impact. A stroke with no effect has an angular rotational velocity only in the x-direction, represented by a gyrometric signal along Gx. An effect is given by applying a rotation about the y-axis, thereby increasing the gyroscopic signal along Gy. A stroke is considered to have an effect when |Gy|/(|Gx|+|Gy|)>S3, S3 being a threshold for example equal to 0.4.

The value of |Gy|/(|Gx|+|Gy|) can also be used to have a parameter corresponding to the intensity of the effect.

The type of effect, backspin or topspin, depends on the sign of Gy and the orientation of the X-axis of the racket with respect to the gravity vector:

(sign(Gy))*(projection of \vec{x} onto \vec{g})>0 backspin effect

(sign(Gy))*(projection of \vec{x} onto \vec{g})<0 topspin effect

In a variant or in combination, as illustrated in FIG. 10 it is possible to determine a longitudinal impact strip, wherein the impact of the projectile Pj has taken place, from a variation of the angular rotational velocity G_{z} along the longitudinal axis z over an interval of time immediately following the impact, corrected by an item of information representing the velocity of the racket Ra just before impact.

In the example of FIG. 10, several longitudinal impact strips are defined, in this case three longitudinal impact strips, a high-impact strip, a medium-impact strip, and a low-impact strip.

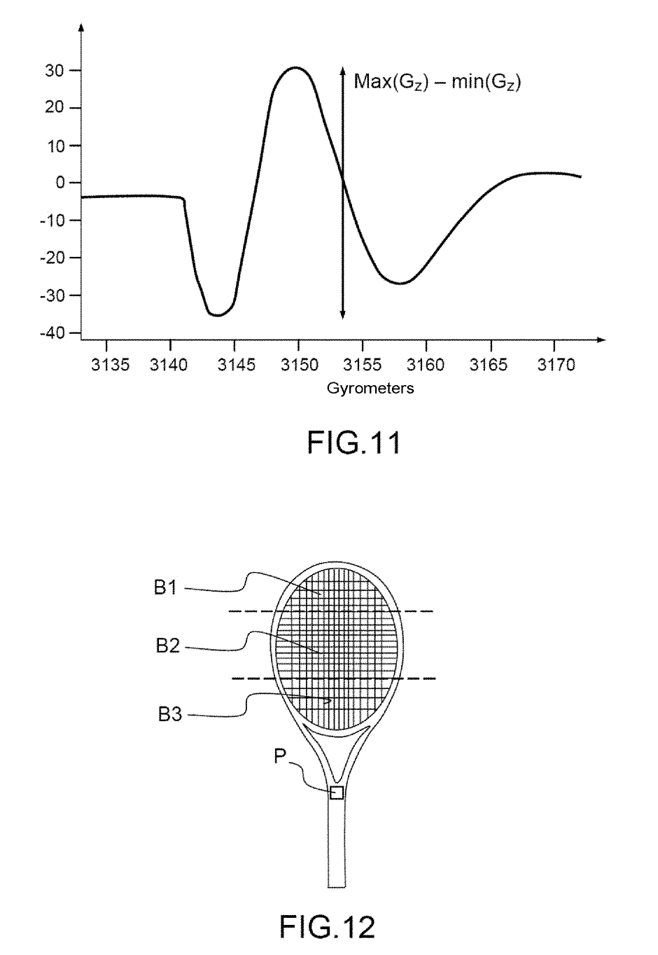

In the event of an impact outside the z-axis, the gyrometer Gz that measures the angular rotational velocity Gz about the z-axis displays an oscillation, as represented in FIG. 11. The downward slope represents the rotation of the racket Ra by reason of the impact, and the re-ascending slope is due to the overcompensation by the action of the player's wrist.

The amplitude of the oscillation max(Gz)-min(Gz) is taken as a measurement of the rotation effect due to an impact outside the axes. The problem with this measurement is that a high impact velocity slightly outside the axes, and a low-velocity impact near the edge of the racket Ra, have the same effect. This means that it is desirable to compensate for the velocity, i.e. the power of the stroke E_{GXY} just before impact. This energy can be represented by the following relationship:

E_{GXY}=|Gₓ|+|G_{Y}|

wherein
Gx and Gy represent the angular rotational velocities of rotation about the x- and y-axes. A normalization using \sqrt{E_{GXY}} works well. To determine if an impact is inside the middle strip or further outside the axis, we introduce C defined by the following relationship:

$$C = \frac{max ( {G}_{Z} ) - min ( {G}_{Z} )}{\sqrt{{E}_{GXY}} ( {t}_{0} - 0.1 s )}$$

A threshold C for example equal to 2 can be used to tell the difference between impacts in the medium band (C<2), and impacts outside the axes (C>2). The threshold can be kept fixed, or can be slightly modified (between 1.7 and 2.1) according to the type of stroke (service, backhand, forehand stroke etc.) in order to increase precision. The best threshold is determined by training on a test basis.

By observing the sign of the drift dGz/dt at the start of the oscillation, we can determine on which side of the center of the impact has taken place.

In a variant or in combination, an impact of the projectile Pj on the racket Ra can furthermore be detected from vibration measurements transmitted by a piezoelectric sensor mounted in a fixed manner on the racket Ra, by comparing a parameter representing vibrations with a threshold. It is for example possible to integrate the signal over a frequency window and to compare the result with this threshold.

For example, as illustrated in FIG. 12, one determines, among several radial impact strips, in this case three radial impact strips B1, B2, and B3, that wherein the impact of the projectile Pj has taken place, from the energy and the phase of the signal transmitted by the piezoelectric sensor P just after impact.

When a ball strikes the racket Ra, it creates vibrations, and these vibrations depend on the position of the impact. By positioning a piezoelectric sensor P between the grip and the bottom of the stringbed of the racket Ra, it is possible to measure the vibrations in such a way as to deduce the position of the impact.

To compute the position of the impact, it is desirable to analyze the fundamental vibration peak in the frequency spectrum (around a frequency that can depend on the racket Ra, in the present example, fₙ=160 Hz) and to determine the energy Φ₁ and the phase t of the signal.

The following relationships exist:

E_{E1}=∫sₘₙ²(t)dt, and

$${Φ}_{1} = atan ( \frac{Im ( {s}_{mn} ( {f}_{n} ) )}{Re ( {s}_{mn} ( {f}_{n} ) )} ) = atan ( \frac{\int {s}_{mn} sin 2 π {f}_{n} t dt}{\int {s}_{mn} cos 2 π {f}_{n} t dt} )$$

wherein:
Im represents the “imaginary part” function,
Re represents the “real part” function, and
Sₙₘ(t) is a time-frequency selection of the signal s(t) provided by the piezoelectric sensor P, for example s(t) for the first 35 ms after impact and for frequencies between 50 Hz and 300 Hz around the central peak (fₙ=160 Hz).

In the case of a separation of the stringbed into radial strips, the signal s(t) conveyed by the piezoelectric sensor P makes it possible to determine in which radial strip the impact has occurred.

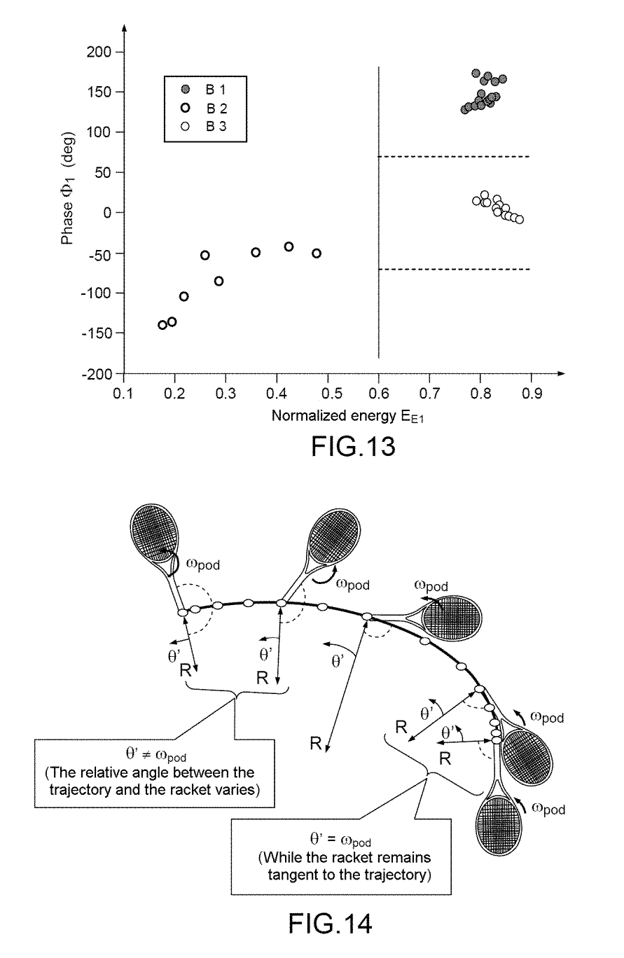

FIG. 13, which represents the phase Φ₁ of the signal s(t) as a function of the normalized energy E_{E1}, does indeed show that it is possible to deduce therefrom a radial strip to which the impact position belongs, in this case B1, B2 or B3.

It should be noted that these features may depend on the type of racket Ra, which means that the procedure can be refined for each racket Ra. For certain rackets it can be beneficial to use two different frequency bands and to use the ratio of the respective normalized energies of these two frequency bands for the x-axis.

By combining the determinations of longitudinal and radial impact zone, an impact zone along the axes x and z of the racket Ra is determined, in a precise manner.

Furthermore, independently or in combination, it is possible, when starting a phase of play, for example during a service, to compute a launch velocity of the projectile Pj on the basis of the axial acceleration values during the acceleration phase of the racket Ra preceding the impact and in the direction of the stroke starting the phase of play.

For example, it is possible to correct the velocity computed from the knowledge of a zone of impact of the projectile Pj and/or of the presence of an effect.

It is possible to compute the ball velocity during a service because it is possible to suppose that the ball has no initial velocity or in other words has zero initial velocity: V (t0)=0.

If it is supposed that at the start of the swing or during the swinging movement of the service, the racket Ra has zero velocity, it is possible to compute the velocity of the racket Ra just before the impact using the measurements of the accelerometer and/or gyrometer of the racket Ra. Furthermore, it is supposed that the ball velocity after the impact is equal to the velocity of the racket Ra just before the impact. Indeed, it is supposed that at the moment of the impact, the racket Ra and the projectile Pj form a single system, and that the projectile Pj thus takes the velocity of the racket Ra.

In practice, it is frequently not possible to measure the acceleration and the angular rotational velocity, just before impact, because the sensors can be saturated by the impact. Consequently, the acceleration of the racket Ra at the start of the swing is measured. Furthermore, at the start of the swing, the longitudinal axis z of the racket Ra is tangent to the trajectory, which means that the angular rotational velocity can be neglected, as illustrated in FIG. 14.

Indeed, FIG. 14 represents the evolution over time of the position of the racket Ra during a service, for various intermediate positions of the racket Ra. In FIG. 14, ω_{pod} represents the angular velocity of the racket measured by the gyrometer or gyrometers, θ′ represents the angular velocity linked to the trajectory or the velocity of the hand of the player, and R represents the instantaneous radius of curvature of the trajectory.

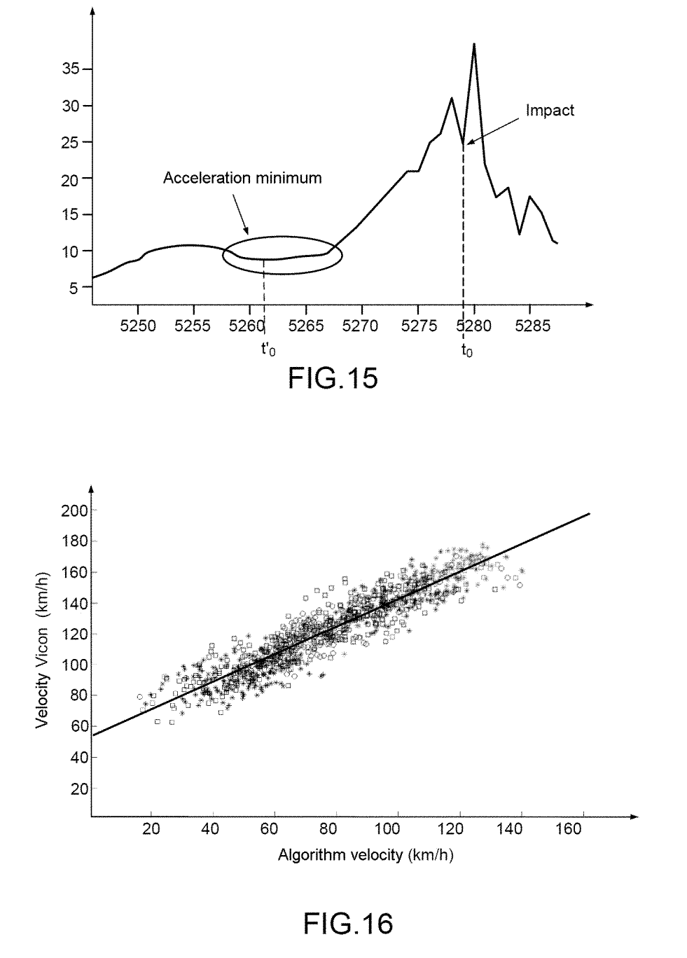

At the start of the service swing, the racket Ra makes a “pause” behind the back of the player. This pause can be considered as a local minimum of the acceleration, as illustrated in FIG. 15. This minimum can be considered as the start of the movement. However, for players having a high standard of play, this minimum may not exist, or not correspond to the start of the movement.

Several criteria are taken into account at the place of the acceleration minimum:
the energy on impact, translated by the value of the acceleration (sum of the acceleration components along the x-, y- and z-axes) just before to.
the slope of the progression of the energy over a few data samples before the impact.

All this can take into account the fact that at least one of the components of the acceleration saturates before impact, over a time frame that is more or less wide according to the level of the player. This time frame can extend over 5 or 6 samples for beginner players (either for one sampling every 5 ms, over 25 or 30 ms), up to 30 samples for the most energetic (150 ms).

The energy on impact can therefore essentially rely on the values of the other components of the acceleration. The higher the energy, the longer the time period before impact over which to integrate.

As to the slope of the acceleration profile, it is the most representative over the 50 ms before impact. The smaller the slope, the greater the acceleration before the impact, and the wider the chosen range of integration to obtain the velocity. If the movement is very strong, the acceleration along the x-axis saturates very quickly and the corresponding signal is constant (horizontal). Because of this, the slopes of the profile of the accelerations computed from the three axes are small.

In summary, the following pattern exists:

MaxAcc representing the acceleration maximum, over all the axes, reached just before impact, and Acc50 representing the acceleration to (t₀−50 ms)
If MaxAcc is below 35, the integration is carried out over 10 samples before impact.
If MaxAcc is between 35 and 45, the integration is carried out over 15 samples before impact.
If MaxAcc is above 45, the integration is carried out over 18 samples before impact.

For each of the three previous tests, the following test is added: If (MaxAcc-Acc50) is above 10.5, the integration is carried out over four more samples (which gives 14, 19, 22 respectively according to the value of MaxAcc).

The estimated velocity can be corrected, taking into account the presence of an effect. In the case of the service, the effect can be a topspin or a slice, for example.

Effects are accounted for in the following manner: at the moment of impact the value of

$$α = \frac{{G}_{Y}}{\vert {G}_{X} \vert + \vert {G}_{Y} \vert}$$

is measured: the greater the rotation about the y-axis, the more marked the effect.

This parameter α is between 0 and 1. The corrected velocity v′ is computed by the relationship v′=v×(0.2−α⁴); indeed, the greater the effect, the more the velocity of the ball or projectile Pj is slowed down with respect to the velocity of the racket. A function decreasing with α makes it possible to re-evaluate the velocity.

Furthermore the velocity can, independently or in combination, be corrected taking into account the centering of the ball, by using the centering criterion C previously defined.

The corrected velocity v″ taking the centering into account follows the following relationship:

v″=v(1+sign(E(C−0.8))×(1.2843−0.1857×C))

with E representing the integer part function, giving:

if C<1.8 sign(E(C−0.8))=0

=else 1

If this correction is applied in combination with the correction taking an effect into account, i.e. after having taken the effects into account using the parameter α described earlier, the centering is also taken into account: indeed, a service wherein the ball is off-center will also be overestimated. The corrected velocity v″ taking the centering into account follows the following relationship:

v″=v′(1+sign(E(C−0.8))×(1.2843−0.1857×C))

=v×(0.2−α⁴)×(1+sign(E(C−0.8))×(1.2843−0.1857×C))

E being the integer part function, giving:

if C<1.8 sign(E(C−0.8))=0

=else 1

The numerical values, such as 1.8, taken into account were obtained by tests.

There will therefore be no change in the velocity if the centering criterion is beneath the threshold of 1.8 (1.8 is chosen according to the last centering results).

Generally, the thresholds required for the operation of the method can advantageously be determined on a test basis representing the scenarios of use.

As illustrated in FIG. 16, the velocity of the projectile is computed in km/h, using training by means of a comparison with radar measurements or optical devices (here a Vicon™ device). The scatter of points obtained, by tests of different players, is represented in FIG. 16. Also, in this case, a linear relationship is identified between the velocity estimated by the algorithm or a quantity representing the velocity estimated by the algorithm, and the velocity measured by radar, which makes it possible to adapt and correct the computed velocity. This method can be easily generalized to other relationships, using polynomials of order 2, 3 or another parameterized function, etc., in order to reproduce more complex functions than a linear relationship. Correspondence tables can also be used, or any other method of function approximation (for example neural networks.)

The location of the player in the game space can be added from data provided by a location system receiver, for example a satellite location system, linked in displacement to the player or to the racket, or a system comprising a video camera.

When the velocity of the racket exceeds a limit rotational velocity of the gyrometer, an extrapolation can be carried out, or a hypothetical extension of a law, of a function or of a quantity beyond the time limits wherein they are objectively observed, of signals provided by the gyrometer over this saturation period. Indeed, a saturated sensor is less accurate, so using an extrapolation, or a hypothetical extension of a law, of a function or of a quantity beyond the time limits wherein they are objectively observed makes it possible to improve accuracy.

Embodiments of the present method makes it possible to provide, in real or delayed time, qualitative and/or quantitative statistics relating to the player's way of playing, by way of a terminal screen, for example a touch-sensitive tablet.

The core data are computed in a computer embedded in the racket, so that in the event of a problem of transmission of the data from the racket to the mobile terminal equipped with display means, the data are not corrupted.

1. A method for analyzing a game of a user of a racket, wherein:
an impact on the racket is detected from representative measurements of a shock to the racket provided by a sensor assembly comprising at least one sensor sensitive to shocks coupled to the racket in a fixed manner in terms of movement;
a moment of impact is associated with a detected impact, from the measurements transmitted by the sensor assembly; and
impacts that are not related to strokes from a set of pre-determined strokes are eliminated to avoid false impact detections by utilizing angular rotational velocity measurements, provided by a gyrometer of the sensor assembly, the gyrometer having at least one measurement axis, the angular rotational velocity measurements taken during an interval of time around said moment of impact.

2. The method as claimed in claim 1, wherein said sensor assembly comprises at least one vibration sensor, and an impact on the racket is detected utilizing measurements of vibrations transmitted by the vibration sensor, by comparison of a parameter representing the vibrations with a threshold.

3. The method as claimed in claim 1, wherein said sensor assembly—comprises an accelerometer with at least one measurement axis, and an impact on the racket is detected when a parameter depending on the variations over time of—axial linear accelerations or variations over time of the angular rotational velocities is above a threshold.

4. The method as claimed in claim 1, wherein impacts that are not related to strokes from a set of predetermined strokes are eliminated utilizing a comparison between a value representing the angular rotational velocity along an axis during an interval of time around the moment of impact and a threshold.

5. The method as claimed in claim 1, wherein said gyrometer comprises at least two measurement axes, impacts that are not related to strokes from a set of predetermined strokes are eliminated utilizing a comparison between a first value representing the angular rotational velocity along a first axis during an interval of time around the moment of impact and a second value representing the angular rotational velocity along a second axis during said interval of time.

6. The method as claimed in claim 1, wherein said gyrometer comprises three measurement axes and said sensor assembly further comprises at least one accelerometer with three measurement axes, an attitude of the racket is determined with respect to a terrestrial frame of reference from the measurements of axial linear accelerations and the measurements of the angular rotational velocities along said measurement axes.

7. The method as claimed in claim 6, wherein a stroke is classified among a set of strokes by association of a stroke with a movement of the racket for which, around the moment of impact, the rotational velocity of the racket is substantially along a determined axis and the attitude of the racket is substantially at a determined attitude.

8. The method as claimed in claim 7, wherein a stroke is further classified among a set of strokes utilizing an item of information representing left- or right-handedness of the player, and of a sign of the angular rotational velocity along the determined axis.

9. The method as claimed in claim 8, wherein the item of information representing the left- or right-handedness of the player is provided by the player or determined automatically during the game.

10. The method as claimed in claim 7, wherein a stroke is detected among a set of strokes by associating a stroke with a determined form of a projection of a vector representing the attitude of the racket onto an axis determined over an interval of time around the moment of impact.

11. The method as claimed in claim 1, wherein said gyrometer comprises at least two measurement axes and the impact is due to a projectile, an intensity of an effect given to the projectile is determined, at the moment of impact, from a comparison of the angular rotational velocity along a first axis during an interval of time around the moment of impact and of the angular rotational velocity along a second axis during said interval of time.

12. The method as claimed in claim 11, wherein said axes comprise a first transverse axis in a direction of a width of the racket and a second transverse axis in a direction of a thickness of the racket, and a backspin effect is differentiated from a topspin effect utilizing a sign of the angular rotational velocity along the second transverse axis and an orientation of the racket during said interval of time.

13. The method as claimed in claim 12, wherein the axes further comprise a longitudinal axis oriented from a shaft to a head of the racket, said gyrometer with at least one measurement axis being configured to provide a rotational velocity along the longitudinal axis, and the impact being due to a projectile, a longitudinal impact strip on a stringbed of the racket, wherein the impact of the projectile is determined from a variation of the angular rotational velocity along the longitudinal axis over an interval of time immediately following the impact.

14. The method as claimed in claim 13, wherein said gyrometer with at least one measurement axis is configured to provide a rotational velocity—along the first transverse axis in the direction of the width of the racket, said determination of the longitudinal impact strip is corrected by an item of information representing the velocity of the racket around the moment of impact.

15. The method as claimed in claim 1, wherein the sensor assembly comprises at least one vibration sensor and the impact is due to a projectile with a radial impact strip, wherein the impact of the projectile is determined utilizing an energy and a phase of a signal transmitted by the vibration sensor due to the impact.

16. The method as claimed in claim 1, wherein the sensor assembly comprises an accelerometer with three measurement axes or a gyrometer with three measurement axes, the impact being due to a projectile, and during a start of a phase of the game, a launch velocity of the projectile is respectively computed from measurements of axial accelerations or measurements of angular rotational velocities during a phase of acceleration of the racket preceding the impact.

17. The method as claimed in claim 16, wherein the computed launch velocity of the projectile is corrected utilizing knowledge of a zone of impact of the projectile or of an intensity of an effect given to the projectile.

18. The method as claimed in claim 1, wherein a location of the player on a game space is determined from data provided by a system for locating the player or the racket.

19. The method as claimed in claim 1, wherein the sensor assembly comprises at least one accelerometer, and when during an interval of time around the moment of impact the signals of said sensor or sensors are saturated, an extrapolation of the signals provided by the sensor or sensors is carried out over said saturation interval of time.

20. A system for analyzing a game of a user of a racket, comprising:
detecting means for detecting an impact on the racket from measurements representing a shock experienced by the racket provided from a sensor assembly comprising at least one sensor sensitive to shocks-coupled to the racket, the detecting means comprising a gyrometer with at least one measurement axis;
associating means for associating a moment of impact with a detected impact, utilizing the measurements transmitted by the sensor assembly; and
eliminating means for eliminating impacts not related to strokes from a set of predetermined strokes to avoid false impact detections by utilizing angular rotational velocity measurements, provided by said gyrometer, taken during an interval of time around said moment of impact.

21. The system as claimed in claim 20, wherein said sensor assembly is mounted on the racket in a fixed manner in such a way that two measurement axes of said sensor assembly form an angle of 45° with a first transverse axis in a direction of a width of the racket and a longitudinal axis in a direction of a length of the racket.

22. The system as claimed in claim 20, wherein said sensor assembly is mounted in a fixed manner in an outer casing equipped with fixing means adapted for being mounted or dismounted as desired on the racket, or is mounted on the racket in a fixed manner.

23. The system as claimed in claim 20, wherein said sensor assembly is mounted in a fixed manner on the racket and comprises an accelerometer and a gyrometer arranged in a shaft of the racket at a bottom of a grip, and a vibration sensor is arranged on the shaft of the racket between the grip and a bottom of a head of the racket.
